(19) United States
(12) Patent Application Publication
(10) Pub. No.: US 2016/0326722 A1
(43) Pub. Date: Nov. 10, 2016

(54) ENERGY-SAVING CONTROL SYSTEM OF EXCAVATOR

(71) Applicant: XUZHOU XUGONG EXCAVATOR MACHINERY CO., LTD, Xuzhou (CN)

(72) Inventors: XIANJUN LI, Xuzhou (CN); QU WANG, Xuzhou (CN); JIASHENG QIN, Xuzhou (CN); YUFENG YANG, Xuzhou (CN); SHUHUI FEI, Xuzhou (CN); YUNXIAN WANG, Xuzhou (CN); LIJING SHI, Xuzhou (CN); YU ZHAO, Xuzhou (CN); YUEFENG JIN, Xuzhou (CN); HONGDA PAN, Xuzhou (CN); YUANLU YIN, Xuzhou (CN); MING ZHANG, Xuzhou (CN); ZHENGHUA WANG, Xuzhou (CN)

(73) Assignee: XUZHOU XUGONG EXCAVATOR MACHINERY CO., LTD

(21) Appl. No.: 15/212,538

(22) Filed: Jul. 18, 2016

Related U.S. Application Data
(63) Continuation of application No. PCT/CN2014/084371, filed on Aug. 14, 2014.

(30) Foreign Application Priority Data
Jul. 11, 2014 (CN) 2014-10332674.1

(51) Int. Cl. E02F 9/22; F15B 13/02; F15B 13/04; F15B 11/08

(52) U.S. Cl. CPC E02F 9/2285; E02F 9/2292; E02F 9/2235; E02F 9/2225; E02F 9/2296; F15B 11/08; F15B 13/028; F15B 13/025; F15B 13/04; F15B 2211/20576; F15B 2211/20546; F15B 2211/25; F15B 2211/526

(57) ABSTRACT

An energy-saving control system of an excavator, including an engine, a main pump (1), a pilot handle, a pilot pressure pump (2), pilot control valves (4), a controller, a main control multi-way valve (3) and an execution mechanism. The main pump controls the execution mechanism via the main control multi-way valve (3). The oil paths connecting the main pump to the execution mechanism are provided with high pressure sensors (6) for transmitting signals to the controller. The main pump adjusts the flow rate thereof according to the pressure of a negative feedback oil path. The oil paths interconnecting the output end of the pilot handle with the main pump is provided with electromagnetic proportional reducing valves (7) and shuttle valves (8). A pilot oil path sequentially passes through the electromagnetic proportional reducing valves (7) and the shuttle valves (8) to control the flow rate of the main pump.

### CROSS-REFERENCES TO RELATED APPLICATIONS

This application claims the priority of PCT patent application: PCT/CN2014/084371, filed on Aug. 14, 2014, which claims priority of Chinese patent application No. 201410332674.1, filed on Jul. 11, 2014, the entirety of all of which is incorporated herein by reference.

### TECHNICAL FIELD

The present disclosure generally relates to the technical field of construction machinery control systems and, more particularly, relates to an energy-saving control system of excavator.

### BACKGROUND

Excavators are construction machinery using buckets to scoop materials above or below a bearing surface and load the materials onto transport vehicles or unload the materials at stockyards. Due to the harsh operating environment and frequent load fluctuations, excavators have more stringent requirements on the overload capability and durability than general construction machinery. As technology advances, the transmission efficiency of the excavator hydraulic system has been significantly improved, however, the fuel consumption of the excavator has not been significantly reduced yet.

Excavators often have three control methods: positive flow control, negative flow control and load sensing control. Positive flow control adopts a positive control pump, in which among various pilot valves, a pilot pressure with a maximum valve opening positively controls the output power of the main pump. The largest pilot pressure is obtained through a real-time detection and comparison of the pressure of the various pilot valves by shuttle valves. The advantages are: the main controller determines the flow demand according to the pilot pressure signal and its trends and controls the hydraulic oil displacement of the main pump, realizing a real-time control of the variable displacement pumps and providing the system with hydraulic oil according to the system demand. The disadvantages are: the output power of the main pump is only determined by the pilot pressure with the maximum valve opening, while the other valves are not involved in the control process, regardless of their valve opening degree.

Negative flow control adopts a return oil pressure variation of the main valve to control the output power of the main pump. The main pump has a smaller output power given a larger amount of the return oil. The negative flow control uses negative control pump, whose controlling oil pressure is directly provided by the return oil pressure in front of the throttle. The advantages are: the negative flow control has a simple structure and automatically adjusts the pump flow rate according to the load, reducing the power consumption to a certain degree. The disadvantages include large fluctuation of the pump flow rate, long response time, and poor maneuverability.

Load sensing control adopts a main control pump, i.e., a high oil pressure of the main control pump, a large output power of the main control pump. The oil pressure is provided by the control pump, and the value of the oil pressure is controlled by a normally-closed (NC) valve, which is inversely proportional to the pressure difference of the jet valves. However, the load sensing control has a complex structure and the applications are limited.

### Technical Solution

To solve the above technical problems, the present invention provides an energy-saving control system of an excavator, which has a simple layout and high energy efficiency. To achieve the above purposes, the present invention provides a technical solution including: an energy-saving control system of an excavator, including: an engine, a main pump, a pilot handle, a pilot pressure pump, pilot control valves, a controller, a main control-multi-way valve and an execution mechanism. The engine is connected to the main pump. The pilot handle and the pilot pressure pump are interconnected to the pilot control valve to form a pilot oil path. The pilot oil path is connected to the main pump, and the main pump controls the execution mechanisms through the main control-multi-way valve. The disclosed energy-saving control system of excavator has the following features. The oil paths connecting the main pump and the execution mechanism are provided with pressure sensors, for transmitting signals to the controller. The main pump is a negative feedback controlled pump, and adjusts the flow rate thereof according to the pressure of a negative feedback oil path.

The oil paths interconnecting an output end of the pilot handle and main pump are provided with electromagnetic proportional pressure reducing valves and shuttle valves. The pilot oil path sequentially passes through the electromagnetic proportional reducing valves and the shuttle valves to control the flow rate of the main pump.

Further, the main pump includes a variable displacement hydraulic pump I and a variable displacement hydraulic pump II. Both variable displacement hydraulic pumps simultaneously supply oil, improving system efficiency.

Further, the pressure sensor includes low pressure sensors and high-pressure sensors. The execution mechanism includes a bucket cylinder, a stick cylinder, a boom cylinder and a swing motor. The low pressure sensors are disposed in incoming oil paths of the cylinders in the execution mechanism, and the high pressure sensors are disposed in the oil path interconnecting the main pump and the main control-multi-way valve.

The low pressure sensors detect various movements of the execution mechanism, and the high pressure sensors determine the operation status of the execution mechanism.

Further, the controller sets a preset pressure value through various programs, and the preset pressure value is determined according to the pressure in the oil paths when the excavator is in a loaded working mode. The preset pressure value determined by the controller may be used to further determine the operation status of the excavator, and the execution mechanism may be controlled more precisely.

### Advantageous Effects

By combining the positive flow control and the negative flow control, the disclosed energy-saving control system of excavator may determine the operation status of the excavator according to the signals transmitting from the pressure sensors disposed in the oil paths, thus, adopt desired control methods. When the excavator is in an unloaded working mode, a combination of the positive flow control and the negative flow control may be adopted. When the excavator is in a loaded working mode, the negative flow control may be adopted. Adopting different control methods for different working modes may provide a sufficient power to the excavator and save the energy. Meanwhile, the oil paths may have a simple and clear layout, the pump flow rate may be stable, and the system pressure loss may be reduced.

### DESCRIPTION OF DRAWINGS

FIG. 1 is a schematic diagram of a hydraulic system of the present invention.

FIG. 2 is a flow chart of the present invention.

In the drawings, 1 is a main pump; 1-1 is a variable displacement hydraulic pump I; 1-2 is a variable displacement hydraulic pump 2 is a pilot pressure pump; 3 is main control-multi-way valve; 4 is a pilot control valve; 5 is a low pressure sensor; 6 is a high pressure sensor; 7 is an electromagnetic proportional pressure reducing valve; and 8 is a shuttle valve.

### DETAILED DESCRIPTION

The present disclosure is further described by the accompanying drawings.

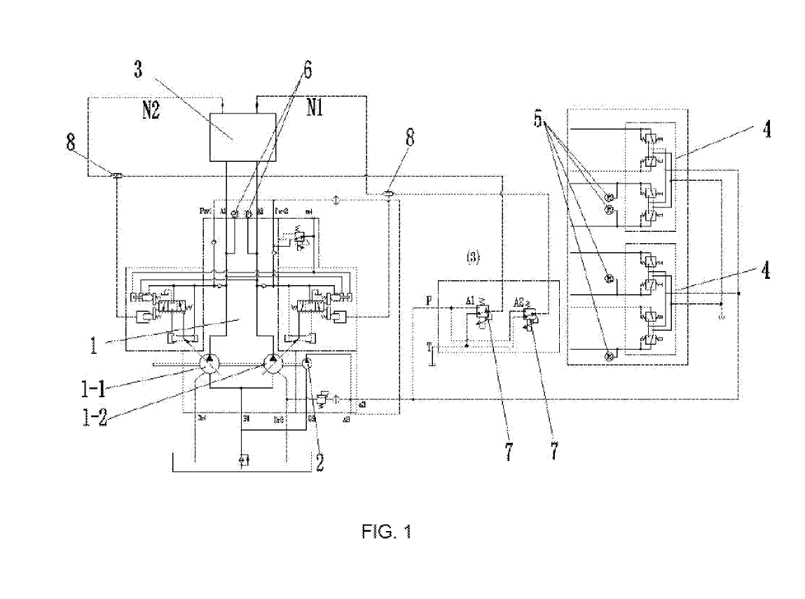

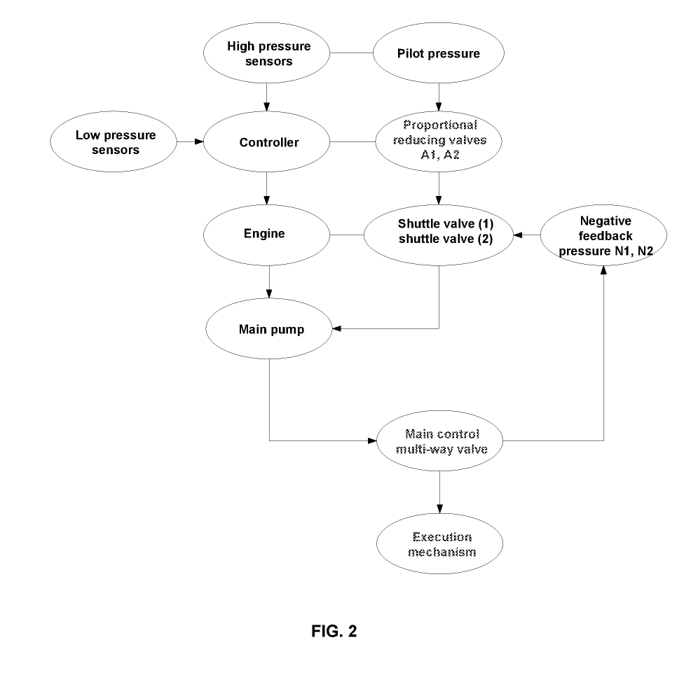

As shown in FIG. 1 and FIG. 2, an energy-saving control system of excavator may include an engine, a main pump 1, a pilot pressure pump 2, pilot control valves 4, a controller, a main control-multi-way valve 3 and an execution mechanism. The engine may be connected to the main pump 1. The pilot pressure pump 2 may be interconnected to the pilot control valve 4 to form pilot oil paths. The pilot oil paths may be connected to the main pump 1, and the main pump 1 may control the execution mechanism through the main control-multi-way valve 3. Pressure sensors maybe disposed in the oil path connecting the main pump 1 and the execution mechanism, and the pressure sensors may transmit signals to the controller. The main pump 1 may be a negative feedback controlled pump, and may adjust the pump flow according to the pressure of a negative feedback oil path.

Electromagnetic proportional pressure reducing valves 7 and shuttle valves 8 may be disposed in the oil paths interconnecting an output end of the pilot handle and the main pump 1. The pilot oil paths may sequentially pass through the electromagnetic proportional pressure reducing valve and the shuttle valves, to control the pump flow of the main pump.

The main pump 1 may further include a variable displacement hydraulic pump I 1-1 and a variable displacement hydraulic pump II 1-2. Both variable displacement hydraulic pumps may simultaneously supply oil, improving system efficiency.

The pressure sensors may include low pressure sensors 5 and high pressure sensors 6. The execution mechanism may include a bucket cylinder, a stick cylinder, a boom cylinder and a swing motor. The low pressure sensors 5 may be disposed in incoming oil paths of the cylinders in the execution mechanism, and the high pressure sensors 6 may be disposed in the oil paths interconnecting the main pump 1 and the main control-multi-way valve 3. The low pressure sensors 5 may detect various movements of the execution mechanism, and the high pressure sensors 6 may determine the operation status of the execution mechanism. The controller may set a preset pressure value through various programs, and the preset pressure value may be determined according to the pressure in the oil path when the excavator is in a loaded working mode. The preset pressure value set by the controller may be used to further determine the operation status of the excavator, thus, the execution mechanism may be controlled more precisely.

Specific workflow is as follows:

Step 1: when the execution mechanism moves, the low pressure sensor 5 transmits a signal to the controller.

Step 2: when the excavator starts working, according to the signal provided by the low pressure sensor 5, the controller determines the movement of the execution mechanism.

Step 3: when the boom is detected to be lowered and rotated, or lowered only, the excavator may be in an unloaded working mode or a loaded working mode.

Step 4: when the controller determines the excavator is in the unloaded working mode according to the signal provided by the high pressure sensor, the shuttle valve 18 is set to a right-pass position, and the workflow of the system is as follows:

The pilot pressure pump 2—the pilot control valves 4—the output end of the pilot handle—the electromagnetic proportional pressure reducing valves 7—the shuttle valves 8—the main pump 1—the main control-multi-way valve 3—the execution mechanism. The output end of the pilot handle may be disposed with the pressure sensors, which may send signals to the controller. Based on the signals provided by the low pressure sensors 5 and the high pressure sensors 6, the controller may determine the working mode of the excavator. The controller may further adjust the current in the electromagnetic proportional pressure reducing valves 7, such that the shuttle valve 8 may be able to compare the pressure of the electromagnetic proportional pressure reducing valves 7 with the negative feedback pressure N1 and N2. The flow rate of the main pump 1 may be adjusted and, meanwhile, the engine power may also be adjusted, such that the engine power and the main pump power may be matched in real-time, and an energy efficient excavator may be realized. The flow rate of the pump and the resulted operating or moving speed of the execution mechanism may be inversely proportional to the output pressure of the electromagnetic proportional pressure reducing valves 7.

Step 5: when the excavator is determined in the loaded working mode, the flow rate of the pump may not be reduced, otherwise the efficiency of the excavator may be reduced. The current of the electromagnetic proportional pressure reducing valve 7 is adjusted, and the shuttle valve 8 is pushed to a left-pass position. The negative feedback oil path is open, the flow rate of the main pump 1 is adjusted by the negative feedback pressure N1 and N2, and the workflow of the system is as follows:

The negative feedback oil path—the shuttle valve 8—the main pump 1—the main control-multi-way valve 3—the execution mechanism.

The negative feedback pressure N1, N2 may keep adjusting the flow rate of the main pump 1 to accommodate the required working load. In this case, the negative flow control may be adopted, such that the working load requirement may be satisfied, the waste of the hydraulic oil may be reduced, and the energy may be saved.

Step 6: when the low pressure sensor 5 detects the boom is lowered and rotated, the pressure of the high pressure sensor 6 has to be examined by the controller. When the pressure of the high pressure sensor 6 is lower than the preset pressure value, the excavator is in the unloaded working mode, and Step 4 has to be performed.

When the pressure of the high pressure sensor 6 is higher than the preset pressure value, the excavator is in the loaded working mode, and Step 6 has to be performed.

When the low pressure sensor 5 detects that only the boom is lowered, Step 4 has to performed.

By combining the positive flow control and the negative flow control, the disclosed energy-saving control system of excavator may determine the operation status of the excavator according to the signals sent from the pressure sensors disposed in the oil paths and, meanwhile, adopt desired control methods. When the excavator is in the unloaded working mode, a combination of the positive flow control and the negative flow control may be adopted. When the excavator is in the loaded working mode, the negative flow control may be adopted. Adopting different control methods for different working modes may provide a sufficient power to the excavator and save the energy. Meanwhile, the oil path may be simple and clear, the pump flow rate may be stable, and the system pressure loss may be reduced.

What is claimed is:

1. An energy-saving control system of an excavator, comprising:
an engine, a main pump (1), a pilot handle, a pilot pressure pump (2), pilot control valves (4), a controller, a main control-multi-way valve (3), and an execution mechanism, the engine is connected to the main pump (1), the pilot handle, the pilot pressure pump (2) and the pilot control valves (4) are interconnected to form a pilot oil path, the pilot oil path is connected to the main pump (1), and the main pump (1) controls the execution mechanism through the main control-multi-way valve (3), wherein:
oil paths connecting the main pump (1) to the execution mechanism are provided with pressure sensors for transmitting signals to the controller;
the main pump (1) is a negative feedback controlled pump, and the main pump adjusts a flow rate thereof according to a pressure of a negative feedback oil path;
the oil path interconnecting an output end of the pilot handle with the main pump (1) is provided with electromagnetic proportional reducing valves (7) and shuttle valves (8); and
the pilot oil path sequentially passes through the electromagnetic proportional reducing valves (7) and the shuttle valves (8) to control the flow rate of the main pump (1).

2. The energy-saving control system of the excavator according to claim 1, wherein the main pump (1) includes a variable displacement hydraulic pump I (1-1) and a variable displacement hydraulic pump II (1-2).

3. The energy-saving control system of the excavator according to claim 1, wherein:
the pressure sensors include low pressure sensors (5) and high-pressure sensors (6);
the execution mechanism includes a bucket cylinder, a stick cylinder, a boom cylinder and a swing motor;
the low pressure sensors (5) are disposed in incoming oil paths of the cylinders in the execution mechanism; and
the high pressure sensors (6) are disposed in the oil paths interconnecting the main pump (1) and the main control-multi-way valves (3).

4. The energy-saving control system of the excavator according to claim 1, wherein:
the controller sets a preset pressure value using a program, and
the preset pressure value is determined according to a pressure in the oil paths when the excavator is in a loaded working mode.

5. The energy-saving control system of the excavator according to claim 2, wherein:
the controller sets a preset pressure value using a program, and
the preset pressure value is determined according to a pressure in the oil paths when the excavator is in a loaded working mode.

6. The energy-saving control system of the excavator according to claim 3, wherein:
the controller sets a preset pressure value using a program, and
the preset pressure value is determined according to a pressure in the oil paths when the excavator is in a loaded working mode.
